(19) United States
(12) Patent Application Publication
(10) Pub. No.: US 2021/0234152 A1
(43) Pub. Date: Jul. 29, 2021

(54) MATERIAL FOR USE IN A BATTERY, A BATTERY AND A METHOD OF MANUFACTURING A MATERIAL FOR USE IN A BATTERY

(71) Applicant: City University of Hong Kong, Kowloon (HK)

(72) Inventors: Yau Wai Denis Yu, Mid-Level (HK); Pui Kit Lee, Kowloon (HK); Tian Tan, Kowloon (HK)

(21) Appl. No.: 16/775,353

(22) Filed: Jan. 29, 2020

(51) Int. Cl. H01M 4/134; H01M 4/485; H01M 4/02

(52) U.S. Cl. CPC H01M 4/134; H01M 2004/021; H01M 4/485

(57) ABSTRACT

A material for use in a battery includes an active material arranged to undergo chemical reaction during charging and/or discharging of battery, and one or more metal atoms arranged to hold and inactivate one or more oxygen atoms of the active material during the charging and/or discharging of the battery.

### TECHNICAL FIELD

The present invention relates to a material for use in a battery, although not exclusively, to an anode material having metal atoms preloading thereto for battery applications.

### BACKGROUND

Lithium-ion batteries (LIB) may be used in many portable electronics, power tools as well as electric and also internal combustion engine vehicles etc. In general, LIBs may consist of a lithium-containing positive electrode material and a lithium-accepting negative electrode material. During charging, lithium from the positive electrode is transferred to the negative electrode. During discharging, some of the lithium is transferred back to the positive electrode. Coulombic efficiency is defined as the ratio of the lithium ions transferred to the negative electrode during charging over that removed in each cycle during discharging.

LIBs have so far been the main choice of battery for applications in renewable energy which requires substantially large energy storage systems. However, current material used in LIBs generally gives a low storage capacity and thus only stores a small amount of energy per charge, leading to unsatisfactory battery performances.

### SUMMARY OF THE INVENTION

In accordance with a first aspect of the present invention, there is provided a material for use in a battery comprising: an active material arranged to undergo chemical reaction during charging and/or discharging of battery; and one or more metal atoms arranged to hold and inactivate one or more oxygen atoms of the active material during the charging and/or discharging of the battery.

In an embodiment of the first aspect, the metal atom forms a complex with the active material.

In an embodiment of the first aspect, the metal atom is arranged to bind the oxygen atom of the active material within the complex.

In an embodiment of the first aspect, the metal atom is bonded to the oxygen atom of the active material through covalent bond.

In an embodiment of the first aspect, the metal atom retains a binding with the oxygen atom during charging and/or discharging of the battery.

In an embodiment of the first aspect, the metal atom reacts with the oxygen atom to form an oxide within the complex.

In an embodiment of the first aspect, the oxide forms at least one of an amorphous material and a crystalline material.

In an embodiment of the first aspect, the Coulombic efficiency of the material is improved through the holding and inactivation of the oxygen atom by the metal atoms.

In an embodiment of the first aspect, the metal atom is selected from Na, K, Rb, Cs, Ca, Al, Mg, Sr, Sc, Y, Zr, Ti, La, Ce, and Hf.

In an embodiment of the first aspect, the metal atom is inserted to the active material thereby holding and inactivating the oxygen atom.

In an embodiment of the first aspect, the metal atom is inserted to the active material in a form including at least one of metal element, metal hydroxide, metal acetate, metal nitrate, and metal carbonate.

In an embodiment of the first aspect, the active material is selected from a metalloid element, a metal element or an oxide thereof.

In an embodiment of the first aspect, the metalloid element is selected from Si, Ge, and Sb.

In an embodiment of the first aspect, the metal element is selected from Zn, Ga, In, Sn, Pb, and Bi.

In an embodiment of the first aspect, the active material is SiOₓ and includes at least one of Si, SiO and SiO₂.

In an embodiment of the first aspect, the particle sizes of the active material are ranged from 5 nm to 10 μm.

In an embodiment of the first aspect, the active material is an anode material in the battery.

In accordance with a second aspect of the present invention, there is provided a battery comprising an anode formed by the material in accordance with the first aspect of the present invention, a cathode, and an electrolyte in ionic connection with the cathode and the anode.

In an embodiment of the second aspect, metal ions from the cathode are transferred to the anode during charging of the battery and transferred back to the cathode during discharging of the battery respectively.

In an embodiment of the second aspect, the metal ions are free from trapping by the oxygen atom in the anode during the discharging of the battery.

In an embodiment of the second aspect, the Coulombic efficiency of the anode remains substantially constant after a predetermined number of cycles of charging and discharging of the battery.

In an embodiment of the second aspect, the metal element of the metal ions is selected from lithium, sodium, and magnesium.

In accordance with a third aspect of the present invention, there is provided a method of manufacturing a material for use in a battery comprising the steps of: preloading an active material with one or more metal atoms, wherein the active material is arranged to undergo chemical reaction during charging and/or discharging of battery and wherein the metal atom is arranged to hold and inactivate one or more oxygen atoms in the active material during the charging and/or discharging of the battery.

In an embodiment of the third aspect, the metal atom is preloaded to the active material by annealing the active material and a material containing the metal atoms in at least one of helium, nitrogen and argon at an annealing temperature ranged from 500° C. to 1100° C.

In an embodiment of the third aspect, the first cycle Coulombic efficiency of the battery increases when the annealing temperature increases.

In an embodiment of the third aspect, the metal atom is preloaded to the active material by ball-milling or high energy ball-milling the active material and the material containing the metal atoms, mixing the active material and the material containing the metal atoms, and subsequently heat treating in at least one of helium, nitrogen and argon.

### BRIEF DESCRIPTION OF THE DRAWINGS

Embodiments of the present invention will now be described, by way of example, with reference to the accompanying drawings in which:

FIG. 1 is an illustration of the preloading of metal atom a material for use in a battery in accordance with one embodiment of the present invention;

FIG. 2 is a plot showing first cycle charge-discharge curves of various SiO materials with Na₂CO₃ treatment;

FIG. 3 is a plot showing first cycle charge-discharge curves of various SiO materials with Al treatment;

FIG. 4A is a plot showing the relationship between the potential and capacity of SiO material annealed with 2.5% Na₂CO₃ at different temperature;

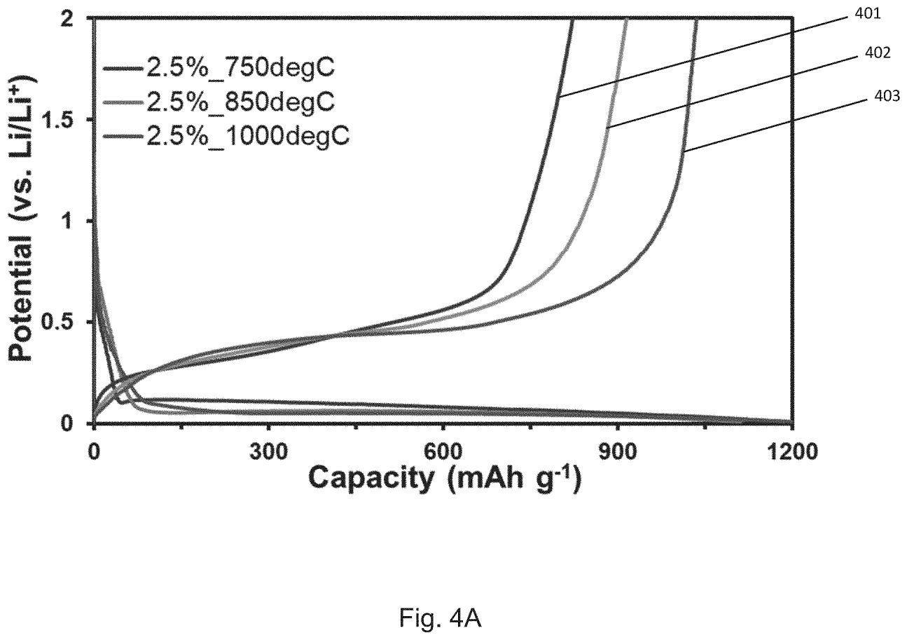

FIG. 4B is a plot showing the relationship between the potential and capacity of SiO material annealed with 5% Na₂CO₃ at different temperature; and

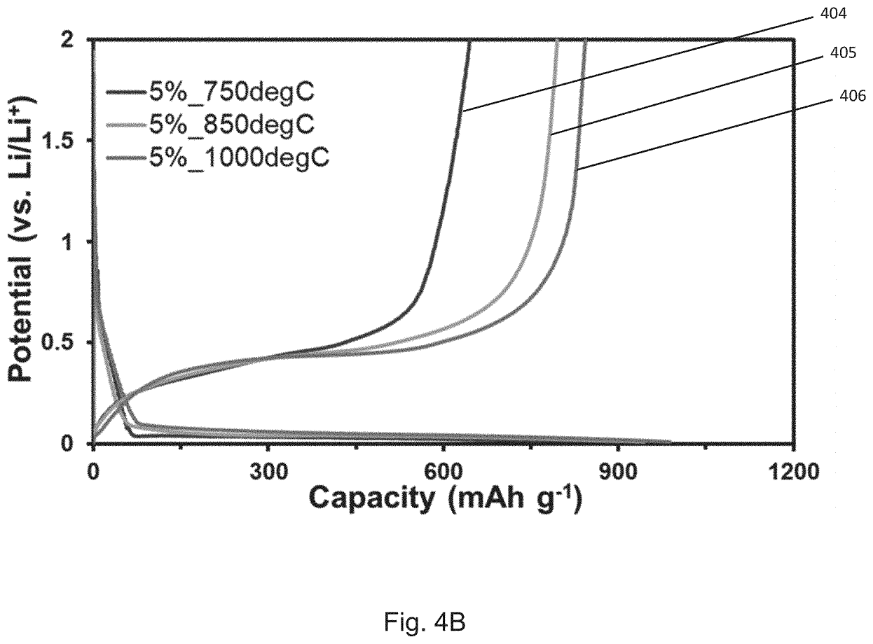

FIG. 5 is a plot showing first cycle charge-discharge curves of SiO materials with K₂CO₃ treatment.

### DETAILED DESCRIPTION OF THE PREFERRED EMBODIMENT

The inventors have, through their own research, trials and experiments, devised that metalloid and metalloid oxides such as Si-based, Ge-based, Sb-based materials are potential high-capacity negative electrode for lithium-ion battery applications. However, high-surface-area metalloid (e.g. Si) particles are highly reactive, and oxygen in the lattice can reduce overall available capacity of the electrode material and also the reversibility of the lithium insertion and extraction by trapping lithium within the material.

Lithium-ion (Li⁺) can be stored by reacting with Si during charging and released during discharging. Ideally, the Coulombic efficiency of a negative electrode should be close to 100%, i.e. the amount of lithium-ion arriving at the negative electrode should be the same as that being removed. If lithium-ion is trapped at the negative electrode, Coulombic efficiency will be less than 100%, and the available capacity and energy density of the battery, which depends on the amount of reversible lithium-ion, will be lower.

For example, typical graphite material used in commercial lithium-ion batteries have a first cycle Coulombic efficiency of about 90-95%. However, if high-capacity metalloid or metalloid oxide such as Si-based materials with SiOₓ where 0≤x≤2 is used as negative electrode materials for lithium-ion batteries, the first cycle Coulombic efficiency is dropped to 70% or below.

The inventors have devised that the oxygen in the negative electrode material, which can be on the surface of the material or inside the bulk, have negative effect on the charge-discharge process. In particular, some of the oxygen will inactivate the Si, which will reduce the overall amount of Li that can be inserted, and thus decrease the capacity that can be stored. Some of the oxygen will also react with lithium during the lithiation process (i.e. charging process), and form irreversible products where Li are trapped during the lithiation process, and thus reducing the reversibility of Li-ion i.e. first cycle Coulombic efficiency of the material. Accordingly, the lithium is trapped mainly by the oxygen in the lattice, which negates the benefit of the higher capacity of the active material.

The present invention describes a novel metalloid (Me)-based material and its formation method with a small amount of metal (A) out of Na, K, Rb, Cs, Ca, Al, Mg, Sr, Sc, Y, Zr, Ti, La, Ce, Hf pre-loaded into the structure of the material. The metal (A) can react with oxygen (O) in the lattice or on the surface and form a A-Me-O complex i.e. oxide state with the metalloid where the metal atom inactivates the oxygen in the lattice. This may reduce the effect of oxygen and solve the problem of low first cycle Coulombic efficiency. Thus, this improves the electrochemical performance of the metalloid material for battery applications.

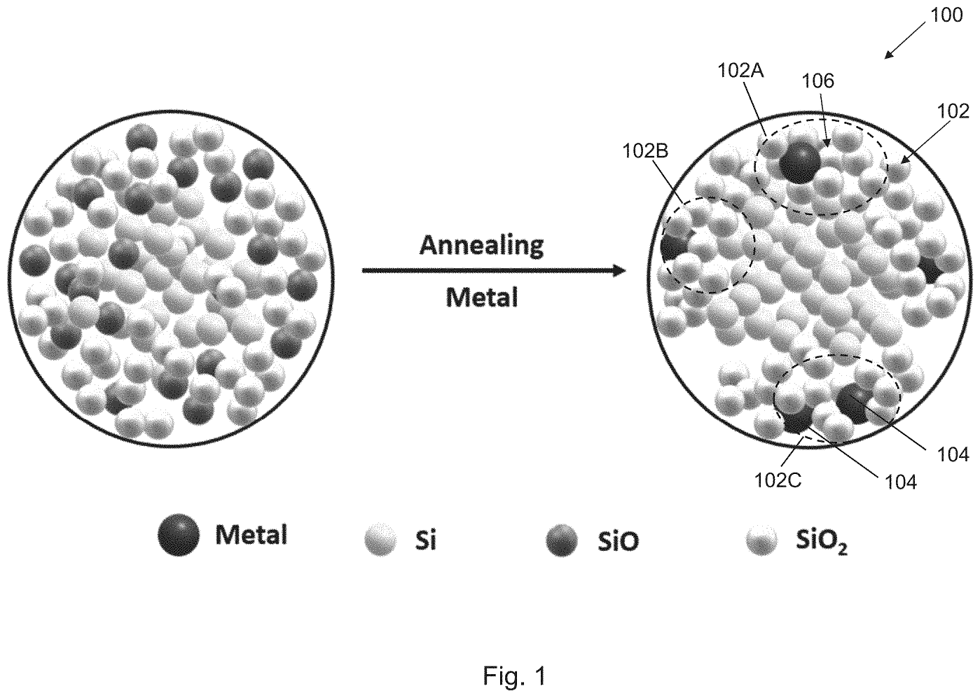

With reference to FIG. 1, there is shown an embodiment of a material 100 for use in a battery comprising: an active material 102 arranged to undergo chemical reaction during charging and/or discharging of the battery; and one or more metal atoms 104 arranged to hold and inactivate one or more oxygen atoms 106 of the active material 102 during the charging and/or discharging of the battery.

In this embodiment, the active material 102 is a material arranged to accommodate an amount of metal ions so as to store the electrical energy. For example, the active material 102 may be a metalloid element (Me) such as Si, Ge, and Sb or a metalloid oxide (MeOₓ), a Si-based material SiOₓ (where x≥0) that are commercially available, and/or high capacity Si-based materials having a plurality of sites for receiving an amount of alkaline metal ions such as Li⁺ and/or Na⁺ ions under a suitable chemical reaction between the active material 102 and the metal ions.

During “charging” (with an external supply of electric current/electrons), lithium ions are attached to the vacant sites on silicon in the active material 102 forming a Si/Li alloy, therefore lithium is “inserted” to the active material 102. In contrast, lithium ions are detached from the Si/Li alloy during “discharging” when the material supplies electrons/electric current to a connected device. The lithium ions may be supplied from an electrolyte in contact with the active material 102.

Without limited by the following examples, the active material 102 may include one or more metal elements such as Zn, Ga, In, Sn, Pb, and Bi, one or more metal oxides such as ZnO, Ga₂O, Ga₂O₃, In₂O₃, SnO, ShO₂, PbO, Pb₃O₄, PbO₂, Pb₂O₃, Pb₁₂O₁₉, Bi₂O₃, one or more alloys of these metal elements and/or a conversion-based material. These materials and the alkaline metal ions may undergo reaction to store or release energy and preferably electrical energy in a battery application.

During “charging”, lithium ions are attached to metal oxide in the active material 102, and convert metal oxide to form lithium oxide and lithium-metal alloy, therefore lithium is “inserted” to the active material 102. During “discharging”, lithium ions are extracted to the electrolyte and metal is converted back to become metal oxide.

With reference back to FIG. 1, the material 100 further includes one or more metal atoms preloaded to the active material 102 through a treatment process. The precursor of the metal atom preferably in a form including at least one of metal element (A), a combination of more than one metal element (A), metal hydroxide (A-OH), metal acetate (A-CH₃COOH), metal nitrate (ANO₃), and metal carbonate (A-CO₃) that comprises a plurality of metal atoms 104 selected from Na, K, Rb, Cs, Ca, Al, Mg, Sr, Sc, Y, Zr, Ti, La, Ce, and Hf.

The preloaded metal atom 104 serves as a “binder” with the active material 102, and hence to bind a plurality of individual portions 102A, 102B and 102C of the active material 102. The metal atoms 104 may form a complex with the active material 102 and bind the oxygen atoms 106 of the active material 102 within the complex.

For instance, the empirical formula of the material 100 may be expressed as AyMeOx where A is a metal atom consisting of Na, K, Rb, Cs, Ca, Al, Mg, Sr, Sc, Y, Zr, Ti, La, Ce, Hf; Me is a metalloid such as Si, Ge, Sb; O is oxygen; 0≤x≤4 and 0≤y≤4. The material 100 may have a primary particle size ranged from 5 nm to 10 μm.

For example, the active material 102 may be SiOₓ made up a fine integration of Si-rich, SiO-rich and SiOₓ-rich regions, each of which or collectively forming oxygen atoms-rich individual portions 102A to 102C on the surface of or within the active material 102. The structure of SiO and SiO includes a plurality of oxygen atoms on the lattice or the surface of the lattice.

In particular, the preloaded metal atoms 104 may hold and inactivate the oxygen atoms 106 of SiO and SiO₂ within the individual portions 102A to 102C of the active material 102 as shown in FIG. 1. Each of the metal atoms 104 and the oxygen atoms 106 share electron pairs therebetween and form a covalent bond. Since the metal atoms 104 binds the oxygen atoms 106, the metal atoms 104 retains a binding with the oxygen atom 106 of the active material 102 during charging and/or discharging of the battery.

Turning now to the detailed description of the structure of the complex, the active material 102, the metal atoms 104 and the oxygen atoms 106 together forms a complex. In this complex, the atoms are arranged in a ordered or disordered manner, thereby forming a plurality of crystalline or amorphous regions within the material 100. Thus, the material 100, with the loading of metal atoms 104, becomes an amorphous or crystalline material. The resulting material incorporating the Si—O formation is not reactive in ambient atmosphere.

By holding and inactivation of the oxygen atoms 106 by the preloaded metal atoms 104, the Coulombic efficiency of the material 100 can be improved dramatically.

These embodiments of material may be used in a battery such as but not limited to a lithium-ion battery, a sodium-ion battery, a magnesium-ion battery or lithium-sulphur battery. Preferably, the active material 102 is used as an anode material of an anode electrode in the battery.

In one example embodiment of a battery structure, there is provided an anode formed by the material 100, a cathode, and an electrolyte in ionic connection with the cathode and anode through which ions are movable during charge and discharge cycles.

Additionally or optionally, the battery may include a separator arranged to electrically insulate the cathode from the anode. The cathode is suitable for releasing metal ions such as lithium, sodium, and magnesium ions. The anode, on the other hand, receives the metal ions from the cathode.

In each “charging” cycle of the battery, metal ions, such as lithium, sodium, and magnesium ions, from the cathode are transferred to the anode. Subsequently, the metal ions resided in the anode are transferred back to the cathode during the “discharging” stage.

Advantageously, the metal atoms 104 preloaded to the material 100 forming the anode plays an important role in the discharging process of the metal ions. The oxygen atoms 106 in the anode are bound by the preloaded metal atoms 104 and thus the metal ions are free from trapping by the oxygen atoms 106 in the anode during discharging of the battery. Thus, this allows the metal ions to return to the cathode. Accordingly, the Coulombic efficiency of the anode remains substantially constant after a predetermined number of cycles of charging and discharging.

In accordance with an embodiment of the present invention, there is provided a method of manufacturing a material for use in a battery comprising the steps of preloading an active material 102 with one or more metal atoms 104, wherein the active material 102 is arranged to undergo chemical reaction during charging and/or discharging of battery and wherein the metal atom 104 is arranged to hold and inactivate one or more oxygen atoms 106 of the active material 102 during the charging and/or discharging of the battery.

For instance, the metal atoms 104 are preloaded to the active material 102 by annealing the active material 102 and a material containing the metal atoms in at least one of helium, nitrogen and argon at an annealing temperature ranged from 500° C. to 1100° C. Alternatively, the metal atoms 104 may be preloaded to the active material 102 by ball-milling or high energy ball-milling the active material 102 and the material containing the metal atoms, mixing the active material 102 and the material containing the metal atoms, and subsequently heat treating in helium, nitrogen and/or argon.

In one example embodiment, an active sample material 201 made of SiO is made into electrodes on copper current collector with an electrode composition (weight percentage) of SiO: Acetylene Black (AB): Polyacrylic Acid (PAA)=6:1:2. The electrodes are assembled with lithium metal as the counter electrode and 1M LiPF6 in fluorinated ethylene carbonate: diethyl carbonate (FEC:DEC)=1:1 v/v as the electrolyte in a coin cell. The cells are charged and discharged at 150 mA/g between 0.01 and 2 V. The 1st lithiation and delithiation capacities are shown in Table 1. The pristine material 201 with a zero content of Na₂CO₃ shows a low first cycle efficiency of 61.4%.

In addition, active materials made of SiO are ballmilled with 2.5% and 5% of Na₂CO₃ and thoroughly mixed at 200 rpm for 30 mins to form sample materials 202 and 203 respectively. The resulting material 202 and 203 are each heat-treated in Ar at 850° C. with a ramping rate of 5° C./min for 12 hours. The heat-treated materials 202 and 203 are then made into batteries and tested the same way as the active sample material 201. The results are shown in Table 1. As observed, addition of small amount of Na₂CO₃ increases the first cycle efficiency of the material 100 by more than 20%.

Furthermore, an active material also made of SiO, is first annealed at 1000° C. without Na₂CO₃, and then afterwards mixed with 2.5 wt % of Na₂CO₃ and annealed again at 850° C. to form sample material 204. The resulting material 204 after initial annealing at 1000° C. does not give a significant increase in first cycle efficiency, comparing to sample active material 201 which does not involve the initial anneal at 1000° C. This is because the initial annealing at 1000° C. decomposes the material into Si and SiO₂, which prevents the formation of Na—Si—O in the material. Thus, the benefit is only observed when SiO is annealed together with Na₂CO₃, forming a composite with Na—Si—O.

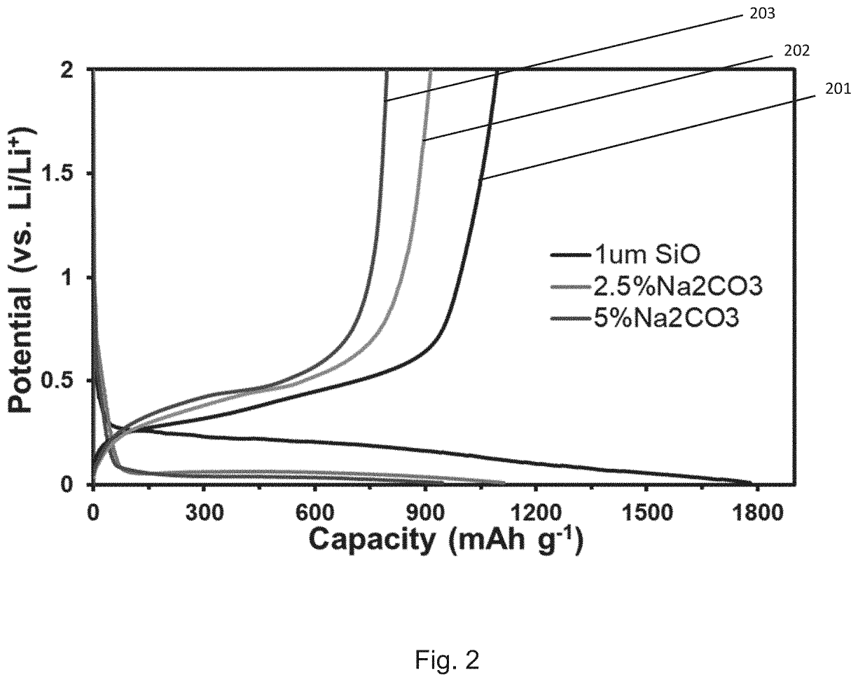

TABLE 1
performance of SiO materials with Na₂CO₃
treatment (cross-reference with FIG. 2)

| | | 1st lithiation | 1st de-lithiation | First cycle |
|---|---|---|---|---|
| | wt % of | capacity | capacity | efficiency |
| | Na₂CO₃ | (mAh g−1) | (mAh g−1) | (%) |
| Comparative | 0 | 1781.3 | 1093.9 | 61.4 |
| example 201 | | | | |
| Example 202 | 2.5 | 1112.2 | 916.2 | 82.4 |
| Example 203 | 5 | 945.2 | 794.6 | 84.1 |
| Comparative | First without | 1373.5 | 963.9 | 70.2 |
| example 204 | Na₂CO₃; | | | |
| (at 1000° C.) | then followed | | | |
| | by 2.5 wt % | | | |

In another example embodiment, active materials made of SiO is ballmilled with 16.9, 28.9 and 38.2 wt % of Al and thoroughly mixed to form sample materials 302, 303, and 304 respectively. The resulting material 302, 303 and 304 are each heat-treated in N₂ at 600° C. for 2 hours. Sample material 401 with a zero content of Al and the resulting materials 302, 303 and 304 are made into batteries. The lithiation and delithiation capacities as well as the first cycle efficiency are tested respectively. The results are shown in Table 2.

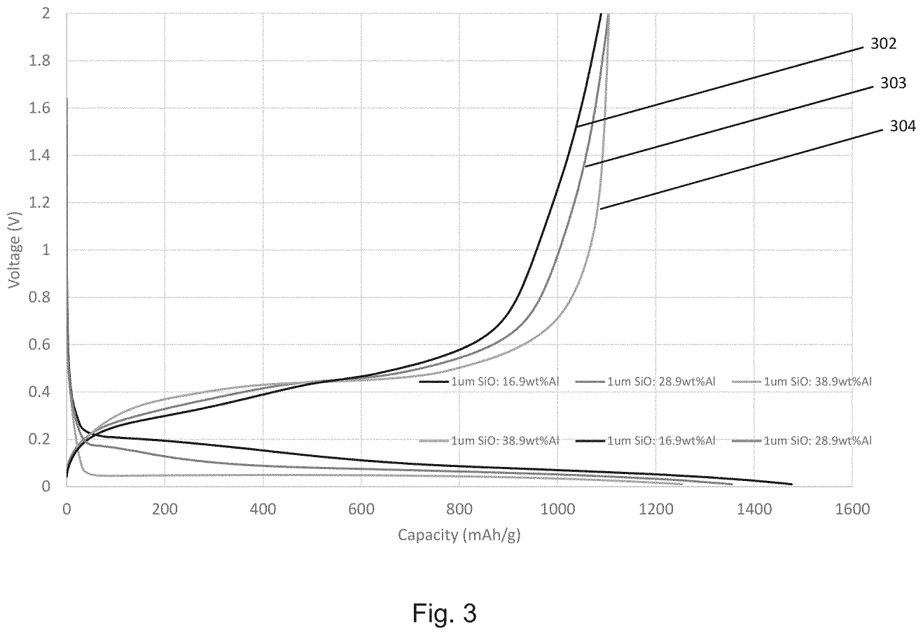

TABLE 2
performance of SiO materials with Al treatment
(cross-reference with FIG. 3)

| | | 1st lithiation | 1st de-lithiation | First cycle |
|---|---|---|---|---|
| | wt % | capacity | capacity | efficiency |
| | of Al | (mAh g−1) | (mAh g−1) | (%) |
| Comparative | 0 | 1781.3 | 1093.9 | 61.4 |
| example 301 | | | | |
| Example 302 | 16.9 | 1626 | 1977 | 73.7 |
| Example 303 | 28.9 | 1241 | 1094 | 88.1 |
| Example 304 | 38.2 | 1137 | 1003 | 88.2 |

The pre-loaded metal inside the material 302, 303 and 304 reacts with oxygen so that it will improve electrochemical performance of metalloid (e.g. silicon) for lithium-ion battery applications. Thus, addition of Al may increase the first cycle efficiency of the resulting materials 302, 303 and 304 by 12 to 27% respectively.

The inventors have also devised that the Coulombic efficiency is relevant to the temperature at which the metal atoms 104 are preloaded to the active material 102.

In one example embodiment, active materials 401 to 406 are annealed with 2.5% and 5% of Na₂CO₃ at different temperature of 750° C., 850° C. and 1000° C. respectively. The results are shown in Table 3.

TABLE 3
Parameters of 1st cycle with 2.5% or 5% Na₂CO₃
under different temperatures (cross-reference with FIGS.
4A and 4B)

| | | | 1^{st} Discharge | 1^{st} Charge | 1^{st} cycle |
|---|---|---|---|---|---|
| | wt % of | | capacity | capacity | efficiency |
| Sample | Na₂CO₃ | Temp | (mAh/g) | (mAh/g) | (%) |
| Sample 401 | 2.5 wt % | 750° C. | 1185.8 | 823.0 | 69.4 |
| Sample 402 | 2.5 wt % | 850° C. | 1112.2 | 916.2 | 82.4 |
| Sample 403 | 2.5 wt % | 1000° C. | 1201.2 | 1036.1 | 86.3 |
| Sample 404 | 5 wt % | 750° C. | 902.6 | 645.5 | 71.5 |
| Sample 405 | 5 wt % | 850° C. | 945.2 | 794.6 | 84.1 |
| Sample 406 | 5 wt % | 1000° C. | 987.7 | 842.8 | 85.3 |

The annealing temperature will affect the reaction and the first cycle Coulombic efficiency. In particular, the first cycle Coulombic efficiency generally increases with annealing temperature i.e. it increases when the annealing temperature increases.

In another example embodiment, active materials made of SiO is ballmilled thoroughly with 5 wt % of K₂CO₃ and annealed in Ar at 850° C. with a ramping rate of 5° C./min for 12 hours to form sample materials 501. The heat-treated materials 501 is then made into batteries and tested the same way as the active sample material 201. The results are shown in Table 4. As observed, addition of small amount of K₂CO₃ increases the first cycle efficiency of the material 100 by about 20%.

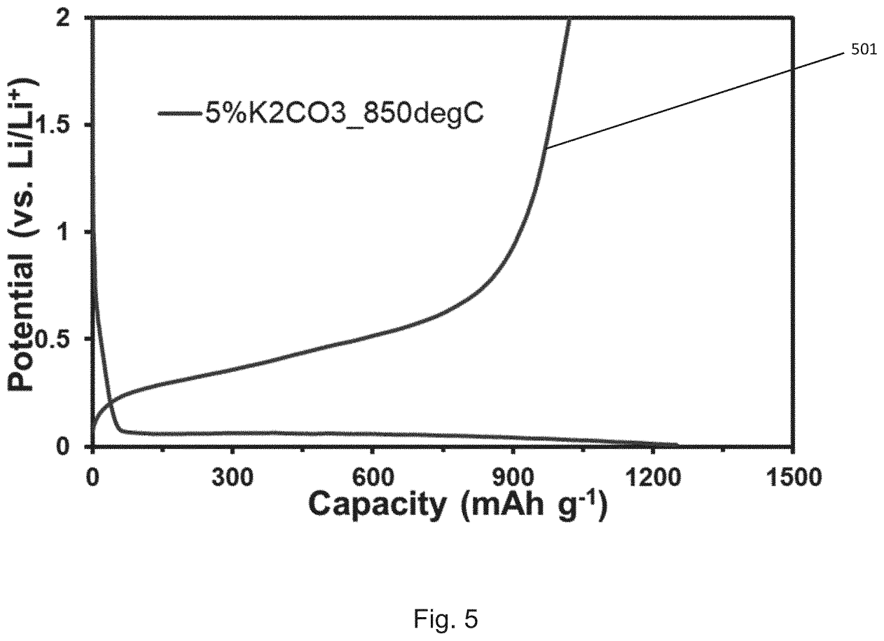

TABLE 4
performance of SiO materials with K₂CO₃ treatment
(cross-reference with FIG. 5)

| | | 1st lithiation | 1st de-lithiation | First cycle |
|---|---|---|---|---|
| | | capacity | capacity | efficiency |
| | wt % of K₂CO₃ | (mAh g−1) | (mAh g−1) | (%) |
| Example 501 | 5 | 1249.5 | 1020.8 | 81.7 |

Advantageously, the present invention can improve the first cycle efficiency and stability of batteries materials, so that they can give higher energy density and last longer in various energy storage applications. By treating the active material with a desirable amount of metal atom at a desirable temperature, the performance of the manufacturing method disclosed in the present invention may be further improved.

In addition, the present invention generates active powders that are stable and can be easily processed in ambient atmosphere, which is much easier to handle than other active powders made by existing methods which require the fabrication to be processed in a strictly controlled atmosphere. The method of the present invention is low cost and thus commercially viable. Thus, the material disclosed in the present invention can be made readily into battery electrodes and give the benefit as mentioned above.

It will be appreciated by persons skilled in the art that numerous variations and/or modifications may be made to the invention as shown in the specific embodiments without departing from the spirit or scope of the invention as broadly described. The present embodiments are, therefore, to be considered in all respects as illustrative and not restrictive.

Any reference to prior art contained herein is not to be taken as an admission that the information is common general knowledge, unless otherwise indicated.

1. A material for use in a battery comprising:
an active material arranged to undergo chemical reaction during charging and/or discharging of battery; and
one or more metal atoms arranged to hold and inactivate one or more oxygen atoms of the active material during the charging and/or discharging of the battery.

2. A material in accordance with claim 1, wherein the metal atom forms a complex with the active material.

3. A material in accordance with claim 2, wherein the metal atom is arranged to bind the oxygen atom of the active material within the complex.

4. A material in accordance with claim 3, wherein the metal atom is bonded to the oxygen atom of the active material through covalent bond.

5. A material in accordance with claim 3, wherein the metal atom retains a binding with the oxygen atom during charging and/or discharging of the battery.

6. A material in accordance with claim 3, wherein the metal atom reacts with the oxygen atom to form an oxide within the complex.

7. A material in accordance with claim 6, wherein the oxide forms at least one of an amorphous material and a crystalline material.

8. A material in accordance with claim 1, wherein the Coulombic efficiency of the material is improved through the holding and inactivation of the oxygen atom by the metal atoms.

9. A material in accordance with claim 1, wherein the metal atom is selected from Na, K, Rb, Cs, Ca, Al, Mg, Sr, Sc, Y, Zr, Ti, La, Ce, and Hf.

10. A material in accordance with claim 1, wherein the metal atom is inserted to the active material thereby holding and inactivating the oxygen atom.

11. A material in accordance with claim 10, wherein the metal atom is inserted to the active material in a form including at least one of metal element, metal hydroxide, metal acetate, metal nitrate, and metal carbonate.

12. A material in accordance with claim 1, wherein the active material is selected from a metalloid element, a metal element or an oxide thereof.

13. A material in accordance with claim 12, wherein the metalloid element is selected from Si, Ge, and Sb.

14. A material in accordance with claim 12, wherein the metal element is selected from Zn, Ga, In, Sn, Pb, and Bi.

15. A material in accordance with claim 1, wherein the active material is SiOₓ and includes at least one of Si, SiO and SiO₂.

16. A material in accordance with claim 1, wherein the particle sizes of the active material are ranged from 5 nm to 10 μm.

17. A material in accordance with claim 1, wherein the active material is an anode material in the battery.

18. A battery comprising an anode formed by the material in accordance with claim 1, a cathode, and an electrolyte in ionic connection with the cathode and the anode.

19. A battery in accordance with claim 18, wherein metal ions from the cathode are transferred to the anode during charging of the battery and transferred back to the cathode during discharging of the battery respectively.

20. A battery in accordance with claim 19, wherein the metal ions are free from trapping by the oxygen atom in the anode during the discharging of the battery.

21. A battery in accordance with claim 18, wherein the Coulombic efficiency of the anode remains substantially constant after a predetermined number of cycles of charging and discharging of the battery.

22. A battery in accordance with claim 18, wherein the metal element of the metal ions is selected from lithium, sodium, and magnesium.

23. A method of manufacturing a material for use in a battery comprising the steps of:
preloading an active material with one or more metal atoms, wherein the active material is arranged to undergo chemical reaction during charging and/or discharging of battery and wherein the metal atom is arranged to hold and inactivate one or more oxygen atoms of the active material during the charging and/or discharging of the battery.

24. A method in accordance with claim 23, wherein the metal atom is preloaded to the active material by annealing the active material and a material containing the metal atom in at least one of helium, nitrogen and argon at an annealing temperature ranged from 500° C. to 1100° C.

25. A method in accordance with claim 24, wherein the first cycle Coulombic efficiency of the battery increases when the annealing temperature increases.

26. A method in accordance with claim 23, wherein the metal atom is preloaded to the active material by high energy ball-milling the active material and the material containing the metal atoms, mixing the active material and the material containing the metal atoms, and subsequently heat treating in at least one of helium, nitrogen and argon.
